(19) United States
(12) Patent Application Publication
(10) Pub. No.: US 2024/0344817 A1
(43) Pub. Date: Oct. 17, 2024

(54) METHOD FOR IMPROVING MEASUREMENT DURING ALIGNMENT OF SHAFTS OF FIRST AND SECOND MACHINES

(71) Applicant: AKTIEBOLAGET SKF, GOTEBORG (SE)

(72) Inventor: Sylvain Georges Henri HUMBERT, Saizerais (FR)

(21) Appl. No.: 18/627,722

(22) Filed: Apr. 5, 2024

(30) Foreign Application Priority Data
Apr. 12, 2023 (DE) 102023203327.5

(51) Int. Cl. G01B 5/25

(52) U.S. Cl. CPC G01B 5/25

(57) ABSTRACT

A method for improving measurements when performing an alignment of the shafts of a first machine and a second machine includes providing to an algorithm a first value measured between two points of the first and second machines, providing to the algorithm a second value measured between one of the two points of the first or second machine and a front foot of the first or second machine, providing to the algorithm a normalized value or standard value between the front feet and the back feet of the first or second machine, and extracting from the algorithm values to compensate for or correct the horizontal and vertical misalignments.

### CROSS-REFERENCE

This application claims priority to German patent application no. 102023203327.5 filed on Apr. 12, 2023, the contents of which are fully incorporated herein by reference.

### BACKGROUND OF THE INVENTION

The present invention relates to measuring systems, and more particularly to a method for improving measurements when performing an alignment of shafts of a first machine and a second machine. Such a method may be implemented with a shaft alignment tool utilizing a tablet and/or a smartphone.

With a power transmission between rotary shafts, for example via a coupling, a first shaft may be part of a first machine, such as a motor, and a second shaft may be part of a second machine, such as a pump, a fan, a gear box, or another appropriate machine. As such, the first shaft is a drive shaft and the second shaft is a driven shaft.

A major part of keeping machinery running smoothly involves regular maintenance, upkeep and ensuring that the machinery is sufficiently lubricated and properly aligned. Correct alignment of the connected shafts ensures smooth, efficient transmission of power from the first machine to the second machine.

However, when the first and second shafts of rotating machinery are misaligned, the risk of costly, unplanned machine downtime rises dramatically. Failure to properly align the two shafts increases the amount of stress on the units, resulting in a range of potential problems that may ultimately have a serious impact a company's bottom line. Shaft misalignment is responsible for as much as fifty percent of all costs related to machinery breakdown.

Shaft misalignment also increases friction, resulting in excessive wear, excessive energy consumption, and the possibility of premature breakdown of machinery. Misalignment also causes excessive wear on bearings and seals, which also leads to premature failure. Further, shaft misalignment may also lead to premature shafts and coupling failure, excessive seal lubricant leakage, failure of coupling and foundation bolts, increased vibration and noise.

Basically, shaft misalignment occurs when the axes of the first and second shafts are not in line or collinear with each other. Such misalignment may be due to parallel or angular misalignment or a combination of both. With parallel misalignment, the axes of the two shafts run parallel to each other, but are offset. With angular misalignment, the shafts extend at an angle to one another or are skew.

Accordingly, proper shaft alignment is one of the most important factors influencing rotating equipment performance. Shaft alignment eliminates or at least reduces risks of breakdowns, reduces unplanned downtime and corresponding loss of production, and minimizes maintenance costs.

Machines need to be aligned in both the horizontal and vertical planes. When performing shaft alignment, different processes may be used. Three such processes involve visual inspection combined with a straightedge or ruler, the use of dial indicators, or the use of laser guided tools.

The conventional process including visual inspection combined with a straightedge or ruler is still in common use. A straightedge is positioned on two bearings supporting one or more shafts while a maintenance inspector visually assesses whether or not the components are properly aligned. Such a rough procedure has the advantage of being quick and relatively easy.

Dial indicators are implemented in another conventional process of measuring misalignment. Dial indicators provide a higher degree of accuracy in comparison to visual inspection with a straightedge.

The process of using laser-guided tools is quick, accurate, and easy to use. In addition, such a process delivers consistently better accuracy than dial indicators and does not require special skills to obtain accurate results virtually every time. Shaft alignment laser guided tools typically consist of two units, each capable of emitting a precise laser beam and detecting a laser beam from the other unit, and a handheld control device.

Laser alignment processes provide a marked improvement in accuracy compared to other conventional processes. Also, a laser-driven shaft alignment device allows an operator to adjust shaft alignment with far more speed and accuracy than either the straightedge or dial processes.

Whichever one of the above processes is used, shims must typically be inserted below one or more feet of at least one of the two machines to align the shafts with respect to each other. In practice, a user loosens the retaining screws of the feet, lifts a machine by a few millimeters, inserts shims under the feet, and then retightens the screws. After installation of the shims, another alignment measurement is usually taken to ensure the job has been properly performed.

The foregoing alignment processes usually provide good results, but still have some drawbacks. One drawback is that the shafts are sometimes not correctly aligned after the installation of the shims according to the recommended thicknesses. In other words, despite the precision of the measurement achieved by the different processes of shaft alignment, and despite the precision of the calculations based on these measurements, misalignments may remain.

Another drawback is the loss of time. That is, adjusting the alignment at least twice takes a relatively substantial amount of time.

### SUMMARY OF THE INVENTION

In view of the discussion above, one object of the present invention is to achieve proper alignment the first time since it is, of course, better not to do the same work twice. Another object of the present invention is to save time in alignment processes.

The above mentioned objects are achieved by the preferred embodiment of the present invention, which is a method for improving measurement when performing an alignment of the shafts of a first machine and a second machine. The method comprises the steps of: providing to an algorithm a first value measured between two points of the first and second machines; providing to the algorithm a second value measured between one of the two points of the first or second machine and a front foot of the first or second machine; providing to the algorithm a normalized value between the front feet and the back feet of the first or second machine; and extracting from the algorithm values to compensate the horizontal misalignment by moving laterally the first machine relative to the second machine and values to compensate the vertical misalignment by shimming under the front and back feet of the first or second machine.

The measured values may be the distance between sensors respectively attached to a shaft of each machine and the distance between a sensor and feet of the first machine. These values are measured during the alignment process.

The normalized value is a reference characteristic, which generally conforms to standards and is available in catalogues, databases, handheld control devices, or other information sources. For example, when a machine is an electric motor, standard dimensions are provided by its reference. Specifically, the motor must be identified to know its standard size. All motors typically have an identification plate which informs an operator of the size of the motor including the shaft height and various dimensions of the motor structure. From this information, it is possible to derive all the standard dimensions of the motor.

Usual dimensions are the transverse distance between the feet, the longitudinal distance between the feet, the distance between the axis of the shaft and the base, shaft diameter, and outside shaft length. Because these dimensions are standard, it is not necessary to measure any of these physical characteristics. As such, when performing an alignment of the shafts of the motor and another machine, any dimension that is a standard physical characteristic of the motor or other conventional machine does not need to be measured. The ability to use standard dimensions instead of taking an actual measurement is particularly beneficial when the machine is installed in a particular place and ready to operate, as it is often difficult to access different parts for taking an actual measurement. Further, taking a normalized value into consideration reduces the risk of error when performing shaft alignment. Due to normalized value(s), the calculations correlated to the alignment process are more pertinent. That is why the measured misalignment better reflects reality or the actual physical state of alignment. In practice, reducing the number of required measurements reduces the risk of error. As a result, the probability of correct adjustment on the first attempt is increased. One advantage that derives from the present method is that, in most cases, the alignment is accurate the first time, such that there is no need to redo the alignment work and no time is wasted.

In the present method, the first machine or the second machine is preferably an electric motor. In most of cases, a motor meets manufacturing standards. With the motor reference, it is easy to find the dimensions of the motor. Such standard or conventional dimensions are typically available in catalogues, databases, handheld control devices, or other known sources of information. As a result, the alignment measurement is more reliable and faster.

Often, with the method, the normalized value is issued from a database, which increases the reliability in utilizing such a value. Such a database typically contains the dimensions of different machines. This broadens the possibilities or potential applications of using the present method.

The database contains an information field to enter the references of a machine. It is useful if the machine is not referenced.

The shaft of the first machine and the shaft of the second machine are connected to each other by means of a coupling joint. The first value is the value measured between the point of the first machine and the coupling joint plus the value measured between the point of the second machine and the coupling joint. That is why the method can be implemented for different alignment processes.

The algorithm calculates the misalignment of the shafts of the two machines. Because the preparatory measurements have been improved, the calculation of misalignment is more accurate and more reliable.

The complicated and time-consuming alignment processes known in the prior art has been, due to the present invention, changed to simple and quick process.

### BRIEF DESCRIPTION OF THE SEVERAL VIEWS OF THE DRAWINGS

In the following, the invention will be described in greater detail with reference to a non-limiting embodiment shown in attached drawing, in which:

FIG. 1 is a top plan view a shaft alignment system according to one embodiment of the invention.

### DETAILED DESCRIPTION OF THE INVENTION

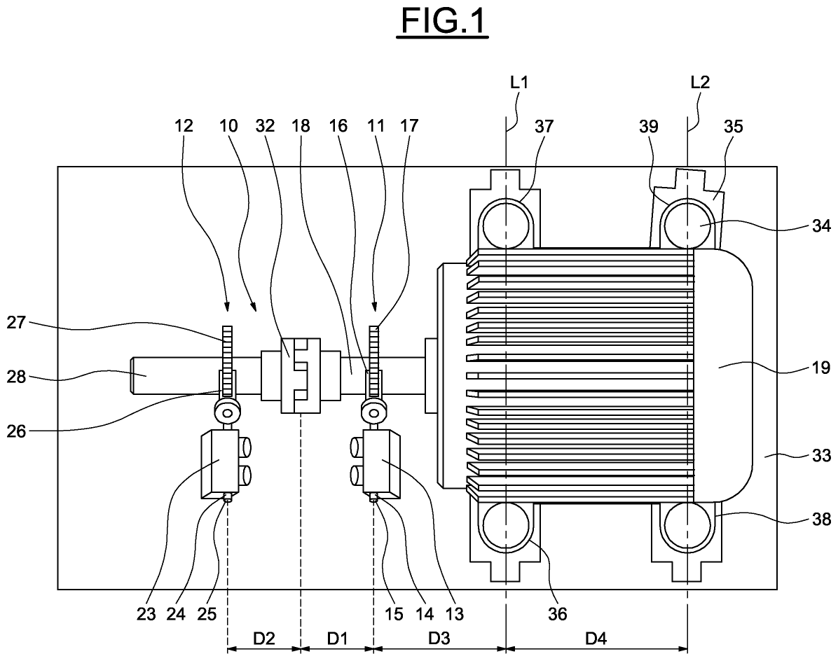

FIG. 1 shows a preferred embodiment of a shaft alignment system 10 according to the present invention. The system 10 comprises a first measuring unit 11 and a second measuring unit 12, and each measuring unit 11, 12 includes a sensor.

By way of non-limiting example, the first measuring unit 11 includes a main part 13, two connecting rods 14, 15, a bracket 16 and a chain 17. In a known way, the bracket 16 and the chain 17 are removably attached to a shaft 18 of a first machine 19, which is preferably formed as an electric motor 19. As such, the shaft 18 is a drive shaft. The rods 14, 15 are secured to the bracket 16, and the main part 13 is secured to the rods 14, 15. Although there are two rods 14, 15, only one is visible in FIG. 1 because one is hidden by the other. This structure allows precise and stable positioning of the main part 13 in relation to shaft 18. Alternatively, other fastening means may be used to secure the main part 13 to the shaft 18.

Similarly, the second measuring unit 12 comprises a main part 23, two connecting rods 24, 25, a bracket 26 and a chain 27. In this case, the bracket 26 and the chain 27 are removably attached to a shaft 28 of a second machine, such as a pump, a fan, a gear box, or another appropriate machine, the second machine not being shown in FIG. 1. In the present case, the shaft 28 is a driven shaft. The rods 24, 25 are secured to the bracket 26 and the main part 23 is secured to the rods 24, 25. Again, although there are two rods 24 and 25, only one is visible in FIG. 1 as the one rod hides the other rod. The structure of the second measuring unit 12 allows precise and stable positioning of the main part 23 in relation to the shaft 28. As with the first measuring unit 11, any other appropriate fastening means may be used to secure the main part 23 to the shaft 28.

The shaft 18 of the motor 19 and the shaft 28 of the driven machine are connected to each other by means of a coupling joint 32. The coupling joint 32 is used to transmit power and torque between the two shafts 18, 28.

In a non-limiting way, the first measuring unit 11 includes a laser emitting a laser beam and the second measuring unit 12 detects the laser beam from the first measuring unit 11. Reciprocally, the second measuring unit 12 includes a laser emitting a laser beam and the first measuring unit 11 detects the laser beam from the second measuring unit 12. For example, the first measuring unit 11 consists of a laser emitter and a laser sensor and the second measuring unit 12 also consists of a laser emitter and a laser sensor. Such laser technology is easy to use and can be implemented with calculation devices using an algorithm.

The motor 19 is held in a stable position on a base 33 by means of screws 34 and washers (not shown). Other attachment means may be used, but screws and washers are economical and easy to implement. The position adjustment of the motor 19 relative to the base is made by means of shims 35 (vertical or height adjustment) and by movement side to side (lateral adjustment). Other position means could alternatively be used, but shims, screws and washers are economical and easy to implement. While not shown in FIG. 1, the second machine that includes the driven shaft 28 is held in a stable position on the base 33 by means of screws and washers. The position adjustment of the second machine relative to the base 33 may also be performed by use of shims.

The motor 19 has two front feet 36, 37 and two back feet 38, 39. The two front feet 36, 37 are aligned along a straight line L1 perpendicular to the shaft 18 and the two back feet 38, 39 are aligned along a straight line L2 also perpendicular to the shaft 18. As such, two screws 34 are aligned on the line L1 and two screws 34 are aligned on the line L2.

Whichever method is used, the alignment of shafts 18, 28 of the first and second machines 19 requires the use of certain dimensions. Some of these dimensions are measured and other dimensions are retrieved from reference sources or materials.

Measured distances are extrinsic values usually obtained by using a measuring device, such as a roll meter or an equivalent measuring means. In a non-limiting way, as shown in FIG. 1, D1 is the distance measured between the first measuring unit 11 and the coupling joint 32. More precisely, D1 is the distance between a connecting rod 14, 15 of the measuring unit 11 and the middle of the coupling joint 32. D2 is the distance measured between the second measuring unit 12 and the coupling joint 32. Again, more precisely, D2 is the distance between a connecting rod 24, 25 of the measuring unit 12 and the middle of the coupling joint 32. Further, D3 is the distance measured between the first measuring unit 11 and the front feet 36, 37. In other words, D3 is the distance between a connecting rod 14 or 15 and the front feet 36, 37 or the line L1.

The three measured values D1, D2 and D3 are provided to an algorithm by any appropriate means. For example, the measured values D1, D2, D3 may be provided at or inputted through an interface like a computer, a tablet, a smartphone or similar device.

Next, certain normalized values are retrieved, which are distances or dimensions that are standard for a particular machine. For the alignment process, the distance D4 is taken into consideration or utilized, D4 being the distance between the front feet 36, 37 and the back feet 38, 39. This distance or dimension is standard and readily available in catalogs, databases, or other reference sources of information on a particular machine. The normalized value D4 is also provided to or entered into the algorithm. Using such standard information that is readily available from reference sources, there is no risk of measurement error, nor any loss of time.

With the values D1, D2, D3 and D4, which is a mix of extrinsic and intrinsic values, the next phase of the alignment process provides more accurate misalignment values. The preferred alignment process is described, for example, in the publication “Coupling Alignment Fundamentals” issued by Rexnord of New Berlin, Wisconsin, the entire contents of which are incorporated herein by reference.

As misalignment can exist in many directions, it is conventional to describe these misalignments in two planes, the vertical and the horizontal. The other type of alignment, which is often overlooked, is axial misalignment. Specifically, the axial position of the coupled shafts 18, 28 may change as a result of many factors.

In a preferred embodiment according to the present invention, the first measuring unit 11 is mounted on the shaft 18 of the first machine (e.g., motor 19) and measures the distance to the second measuring unit 12 on the other shaft 28. Then, the measurement is “reversed” and the second measuring unit 12 measures the distance to the first measuring unit 11. Each of these measurements provide D1+D2, the distance between the position of the first measuring unit 11 on the motor 19 and the position of the second measuring unit 12 on the second machine. The two shafts 18, 29 are rotated to different angular positions to enable the measuring units 11, 12 to provide values at these different angular positions.

As known, the distance D3 from where the first measuring unit 11 is located on the motor 19 to the front motor feet 36, 37 may be measured by means of a straightedge or similar device. And the normalized distance D4, which is the distance between the front feet 36, 37 and the back feet 38, 39, is collected or retrieved.

With all these values and with the implementation of the algorithm, it is possible to correct the horizontal misalignment by moving the motor 19 laterally side to side relative to the driven machine, and to correct the vertical misalignment by shimming under the motor feet 36, 37, 38, 39. The horizontal and vertical corrections of misalignment also allow correction of axial misalignment.

Specifically concerning the vertical misalignment, the algorithm provides the height corrections to be made to each foot 36, 37, 38, 39, and the correct shim thicknesses may be selected.

In addition, the algorithm can document the values, which may then be used as a benchmark for future alignment inspections. The algorithm may be designed to come with a built-in step-by-step alignment process, from preparation, inspection, and evaluation through correction, reporting and analysis. It can still be expected that a database may store data regarding visual inspections on oil leakage, oil level, foundation bolt status, and wear indications.

While a preferred embodiment has been described, according to the invention, it is realized that variations and modifications within the scope of the attached claims may exist. For example, conventional processes, other than those using laser technology, may be used.

The invention may advantageously be used in all applications where two shafts must be aligned plane-parallel or essentially plane-parallel.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A method for improving measurements when performing an alignment of the shaft of a first machine and a shaft of a second machine, the method comprising the steps of:
providing to an algorithm a first value measured between a point on a first machine and a point on a second machine;
providing to the algorithm a second value measured between one of the two points of the first and second machines and a front foot of the first machine or of the second machine;
providing to the algorithm a normalized value, the normalized value being a distance between the front feet and the back feet of the first machine or a distance between the front feet and the back feet of the second machine; and
extracting from the algorithm values to compensate for horizontal misalignment by moving laterally the first machine relative to the second machine and values to compensate for vertical misalignment by shimming under the front and back feet of the first machine or of the second machine.

2. The method according to claim 1, wherein the first machine or the second machine is an electric motor.

3. The method according to claim 1, wherein the normalized value is issued from a database.

4. The method according to claim 3, wherein the database contains the dimensions of a plurality of different machines.

5. The method according to claim 3, wherein the database contains an information field for entry of reference dimensions of a machine.

6. The method according to claim 1, wherein the shaft of the first machine and the shaft of the second machine are connected to each other by means of a coupling joint, the first value being the sum of a value measured between a point on the first machine and the coupling joint and a value measured between a point of the second machine and the coupling joint.

7. A method for improving measurements when performing an alignment of the shaft of a first machine and a shaft of a second machine, the method comprising the steps of:
providing a first value to an algorithm, the first value being measured between a point on a first machine and a point on a second machine;
providing a second value to the algorithm, the second value being measured between the point on the first machine and a front foot of the first machine or between the point on the second machine and a front foot of the second machine;
providing a normalized value to the algorithm, the normalized value being a distance between the front feet and back feet of the first machine when the second value is measured from a point on the first machine or a distance between the front feet and back feet of the second machine when the second value is measured from a point on the second machine; and
extracting from the algorithm at least one value to compensate for horizontal misalignment by moving laterally the first machine relative to the second machine and at least one value to compensate for vertical misalignment by shimming under the front feet and the back feet of the first machine or under the front feet and the back feet of the second machine.
